(19) United States
(12) Patent Application Publication
(10) Pub. No.: US 2014/0144896 A1
(43) Pub. Date: May 29, 2014

(54) SYSTEM AND METHOD FOR MANUAL SEAM TRACKING DURING WELDING AND WELDING ASSISTANCE SYSTEM

(71) Applicants: Omer Einav, Kfar Monash (IL); Doron Shabanov, Zur-Yigal (IL); Daniel Spirtus, Holon (IL)

(72) Inventors: Omer Einav, Kfar Monash (IL); Doron Shabanov, Zur-Yigal (IL); Daniel Spirtus, Holon (IL)

(73) Assignee: WELDBOT LTD., Kadima (IL)

(21) Appl. No.: 14/131,419

(22) PCT Filed: Jul. 4, 2012
(86) PCT No.: PCT/IL12/50231

§ 371 Date: Jan. 7, 2014

Related U.S. Application Data
(60) Provisional application No. 61/505,552, filed on Jul. 8, 2011.

(51) Int. Cl. B23K 9/095

(52) U.S. Cl. CPC B23K 9/0956
USPC 219/124.1

(57) ABSTRACT

A system for improved manual welding is provided. The system includes a novel nozzle for maintaining fixed electrode-work piece distance, sensors such as optical, temperature, ultrasound and the like for providing feedback on weld quality, and indicators such as a video screen indicating actual vs. desired weld characteristics (such as speed, size, position, and the like). Furthermore actuators in the device allow for control over movement either perpendicular to the weld seam, parallel to it, or both. For example an eccentric axis allows for automation of the welding weave motion.

### BACKGROUND

1. Technical Field

The invention concerns seam tracking during welding, including a sensor based welding-assistance system providing feedback to the welder while welding.

2. Description of Related Art

Arc welding is a method for joining metals using an electric arc between an electrode and base material to melt or otherwise fuse the metals at the welding point. The process uses either direct or alternating current, and consumable or non-consumable electrodes. The welding region is generally protected by some type of shielding gas, vapor, and/or slag.

Since welding is in many cases a manual operation, a body of theory and experience has grown around the processes involved, which require some degree of manual dexterity as many trade skills do. Welding is often considered rather difficult for beginners, with tens or hundreds of hours experience required to learn basic welding skills Construction and other professional welding jobs often require welding certification, which in turn may require proof of welding course work, testing, guild membership, periodic retesting, and the like.

Since welds can be as strong as the base metal(s) involved (when done well) or can lack any structural integrity whatsoever (when done poorly), and since furthermore large building elements and important structural roles may rely on welds, the quality of the welds can be crucial to the integrity of a structure.

The effects of welding on the material surrounding the weld can be detrimental, depending critically upon the materials involved and the heat input of the welding process used. The so-called heat affected zone or HAZ can be of varying size and strength; its size and nature depend upon such factors as the welding rate, welding current, and the thermal diffusivity of the base material. The amount of heat input by the welding process plays an important role as well; arc welding falls between the two extremes of laser welding and oxyacetylene welding, with the individual processes varying somewhat in heat input.

The factors affecting weld quality and HAZ include current setting, length of arc, angle of electrode, manipulation of the electrode, speed of travel, and correct rod or filler selection.

Each of these factors can vary depending upon situation. For example, in the case of shielded-gas (aka stick) welding, the arc length should not exceed the diameter of the metal portion (core) of the electrode. Holding the electrode too closely decreases welding voltage. This creates an erratic arc that may extinguish itself or cause the rod to freeze, as well as producing a weld bead with a high crown. Excessively long arcs (generally due to too much voltage) produce spatter, low deposition rates, undercuts and possible porosity.

Many beginners weld with too long of an arc, producing rough beads with (as mentioned above) excessive spatter, this comprising chunks of molten metal that fly about during the welding and cool on the base material forming a rough bumpy surface. A practiced welder uses a very particular technique including tight, controlled arc length that improves bead appearance, creates a narrower bead and minimizes spatter. Achieving this proficiency can take years, and the learning process is hampered by the lack of any immediate feedback on the quality of one's technique, since the bead is generally a white hot zone that is difficult to see, and when cooled the bead is hidden by a layer of slag. Only after the bead has cooled and the slag chipped off can one even see the actual result of one's technique. An arc that is too short will make the rod stick. Too long and large drops of melted metal will drip off the rod and it will tend to “blow” and spatter. A long arc also produces uneven bead with poor penetration.

Too little amperage causes a weak arc that is hard to strike. Too much amperage causes a large crater, or a flat bead with excessive spatter.

The rod angle affects the penetration. One common welding technique involves holding the rod nearly perpendicular to the joint to increase penetration; however this can cause slag to get trapped in the weld. Lowering the rod too flat or low lessens the penetration and causes ripples.

Speed affects the amount of rod deposited and the uniformity of the bead. Travelling too fast creates a thin bead with little penetration, while travelling too slow lets the bead build up with edges that overlap the base metal, and on thin metal may form a hole in the base material. The proper travel speed produces a weld bead with the desired contour (or “crown”), width and appearance. To achieve the right contour one adjusts travel speed so that the arc stays within the leading one-third of the weld pool. Slow travel speeds produce a wide, convex bead with shallow penetration, while excessively high travel speeds also decrease penetration, create a narrower and/or highly crowned bead, and possibly undercuts.

To complicate matters, various techniques for different situations have become established. For example welding in horizontal and overhead positions generally uses the “drag” or “backhand” technique, where the welder hold the tool perpendicular to the joint and tilts the tool in the direction of travel approximately 5 to 15 degrees. For welding vertically upwards, one uses a “push” or “forehand” technique, tilting the top of the tool 15 degrees away from the direction of travel.

To create a wider bead on thicker material, one manipulates the electrode from side to side creating a continuous series of partially overlapping circles, or a “Z” shape, a semi-circle, or a stutter-step pattern. Side-to-side motion is generally limited to 2½ times the diameter of the electrode core. To cover a wider area, one makes multiple passes or “stringer beads.”

When welding vertically up, the push technique is used. One must pause slightly at each side to allow the far side of the bead to cool, letting the weld puddle to catch up to the current position, and to ensure solid “tie-in” to the sidewall.

As will be obvious to one skilled in the art one necessarily needs a good view of the weld puddle. Otherwise, it becomes difficult or impossible to ensure welding in the joint, keeping the arc on the leading edge of the puddle, and using the right amount of heat. The generation of smoke by the welding process can also complicate matters due to decreased visibility therethrough.

One problem often encountered by beginner welders without access to special active helmets is that the welding helmet has such a high light blocking factor that until a weld is started, one cannot see the work. Thus one must generally hold the tool close to the work, close the helmet, and start the weld blind, trusting one's sense of proprioception for guidance alone until the weld is started.

For welding on the flat the rod should be angled 10 to 20 degrees from vertical and pulled in the direction of the arrow. The angle of the rod prevents the slag overtaking the rod, which is undesirable as welding over slag causes inclusions in the weld.

In the case of stick welding, the rod becomes shorter as the weld progresses, and it takes a conscious effort to reduce the length of the arc as the rod gets shorter. Excess arc length can lead to an unstable arc. Excess heat and undercutting are common beginner faults.

As will be appreciated the change in rod length for stick welding will also affect the rod angle unless the welder continually adapts his hold. The angle of the rod should also be maintained over the length of the weld. Practice is required to avoid decreasing the lead angle as the weld progresses, as this can result in slag inclusions or cause the arc to extinguish.

As will be clear to one skilled in the art, visual feedback is crucial to follow the seam during the hand motion. Due to the need for a line of sight to the weld seam it is sometimes difficult to provide necessary equipment for delivering the assist gas as may be necessary with various welding technologies such as MIG/TIG, as this equipment can block the welder's line of sight.

Due to the high level of manual dexterity involved in the process, generally each welder manipulates or weaves the electrode in a more or less unique style. Achieving this proficiency can take years, and the learning process is hampered by the lack of any immediate feedback on the quality of one's technique.

As mentioned above a number of factors conspire to make learning the welding arts particularly difficult. The inability to see the work in some conditions, necessity for tight control over bead characteristics which in turn depend on speed, angle, and other factors, and varying techniques for different situations all complicate the welding process.

Hence, an improved method for welding is still a long felt need.

### BRIEF SUMMARY

The invention relates to a device that assists a welder in performing a consistent weld along a seam.

These, additional, and/or other aspects and/or advantages of the present invention are: set forth in the detailed description which follows; possibly inferable from the detailed description; and/or learnable by practice of the present invention.

It is within provenance of the invention to provide a welding device comprising:
a plurality of sensors adapted to sense parameters of a welding bead;
indicating means adapted to indicate to the user the measurements of said sensors;
whereby realtime feedback is provided to a welder concerning parameters of sad welding bead.

It is further within provision of the invention wherein said sensors comprise distance sensors adapted to sense the arc length.

It is further within provision of the invention wherein said sensors comprise position sensors adapted to sense the welding bead position relative to a predetermined desired welding bead position, said position sensors sensing parameters selected from the group consisting of: distance from desired welding bead in the direction parallel to said welding bead; distance from said desired welding bead in the direction perpendicular to said welding bead.

It is further within provision of the invention wherein said sensors comprise speed sensors adapted to measure the speed of production of said welding bead.

It is further within provision of the invention wherein said sensors comprise spool speed sensors adapted to measure the rate of spool consumption.

The welding device of claim 1 further comprising electrode positioning means adapted to move the electrode of said welding gun in a reciprocating movement perpendicular to the direction of said welding bead.

It is further within provision of the invention further comprising programming means adapted to allow the user to set parameters of said positioning means.

It is further within provision of the invention wherein said parameters comprise weaving frequency.

It is further within provision of the invention wherein said measurements comprise measure of the deviation of said welding bead position from the desired welding bead position.

It is further within provision of the invention wherein said nozzle is interchangeable with a set of nozzles adapted for difference welding jobs.

It is further within provision of the invention wherein said gun comprises active cooling means.

It is further within provision of the invention wherein said indicating means are wearable.

It is further within provision of the invention wherein said sensors comprise inertial measurement means.

It is further within provision of the invention further comprising means to calculate and plot the path of said bead.

It is further within provision of the invention further comprising means to measure and store welding parameters from a plurality of trial runs.

It is further within provision of the invention wherein said stored welding parameters are used to indicate desired welding parameters.

It is further within provision of the invention wherein said indicating means are adapted to show desired tool path.

It is further within provision of the invention wherein said indicating means comprise video display means.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which:

FIG. 1 depicts an exemplary system diagram showing the main components of the invention;

FIG. 2 shows a system flow chart;

FIGS. 3a,b show exemplary systems of the invention;

FIG. 4 shows a cross section of one exemplary welding gun of the system;

FIG. 5 shows a few examples of display systems of the invention;

FIG. 6 depicts a number of nozzles of the system;

FIG. 7 shows an example of a nozzle with adjustable standoff;

FIG. 8 shows an embodiment of a nozzle of the system;

FIG. 9 shows another embodiment of a nozzle of the system;

FIG. 10 show another embodiment of a nozzle of the system;

FIG. 11 shows a nozzle of the system;

FIG. 12 represents a pace meter of the invention ;

FIG. 13 depicts a welding gun, screen, and pace meter consistent with certain embodiments of the invention;

FIG. 14 presents a block diagram of an exemplary system.

### DETAILED DESCRIPTION

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for providing a system and method for welding.

In the following detailed description, numerous specific details are set forth in order to provide a thorough understanding of embodiments of the present invention. However, those skilled in the art will understand that such embodiments may be practiced without these specific details. Just as each feature recalls the entirety, so may it yield the remainder. And ultimately when the features manifest, so an entirely new feature be recalled. Reference throughout this specification to “one embodiment” or “an embodiment” means that a particular feature, structure, or characteristic described in connection with the embodiment is included in at least one embodiment of the invention.

The term ‘plurality’ refers hereinafter to any positive integer (e.g, 1,5, or 10).

The term ‘welding’ refers hereinafter to a process for joining metals by means of electric arc, adding a filler material to form a pool of molten material that cools to for a weld.

The present invention, in some embodiments thereof, relates to devices for welding assistance for a welder, and a semi-autonomous welding device for assisting a welder during welding.

The device includes a welding nozzle, welding seam sensor(s), welding gun, feedback unit for the user, control unit, tip movement unit, and accessories.

The welding nozzle may be interchangeable (for instance by means of a quick connection system), and may be of a shape appropriate to the welding requirements. Thus differently shaped nozzles may be provided for butt welding, lap welding, overlap welding, right angle welding, pipe welding and the like. The nozzle may have an adjustable tip to accommodate for different weld scenarios such as flat, right angle, and vertical welding.

It is within provision of the invention that the nozzle be disposable, and in some embodiments the nozzle may be flexible so as to comply to weld geometry.

It is within provision of the invention to include a plurality of sensors.

It is within provision of the invention to include a guidance wheel or wheels to maintain a fixed or controllable electrode-seam distance.

It is within provision of the invention that the nozzle may be perforated, or to have a net shaped frame.

It is within provision of the invention that the nozzle may include a spring mechanism for height compliance.

It is within provision of the invention that the nozzle may have spacers to allow for different tip heights.

It is within provision of the invention that the nozzle may be of a brush type.

The nozzle may be constructed from material such as brass, iron, ceramic, silicon and the like.

The nozzle may include a cooling mechanism that provides a temperature controlled environment for the welding process. This cooling mechanism may use the shielding gas as cooling media, and/or an additional cooling medium can be used. The nozzle may be fitted with various channels for the cooling fluid to allow effective cooling to the desired area. Active cooling can optionally be used for cooling various parts in the system.

In some embodiments of the present invention, a welding sensor is used to provide feedback that can indicate the location of the seam. The sensors are used to provide feedback and/or control concerning the voltage, current, tool-weld distance, weld seam characteristics, temperature, and the like. The sensor (or sensors) may comprise one or more of the following technologies:

Current sensor, voltage sensor, ultrasonic sensors, optical sensors, laser sensors inductive sensors, pressure sensors, proximity detectors, tactile sensors, magnetic sensors, electromagnetic sensors, and others.

The nozzle may be a pneumatic nozzle using external features such as marking means, for example stickers or other markings, which may be preexisting or added by the system.

It is within provision of the invention that the welding gun may include the provision to lead the electrode wire, may include a gas feed, a cooling element, may be a standard commercially available unit that is fitted into the device, a vacuum and/or blower to remove process fumes, and a feedback unit as described below.

In some embodiments of the present invention, the feedback unit provides cues to the user on the location of the seam. The feedback unit, in some embodiments, may indicates the user how to correct his welding motion. In some embodiments of the present invention, the feedback unit corrects only the direction perpendicular to the seam. In some embodiments of the present invention, the feedback unit provides feedback on the speed of the welding gun along the seam.

The feedback means of the system may include one or more of the following: LCD screen; LED indications; audible feedback; tactile feedback; and haptic feedback/control such as pushing the user in the right direction.

In some embodiments of the present invention the control unit provides means to control, measure and indicate to the user various aspects of the welding process.

Various tasks are optionally performed by the controller and may include control over weld parameters such as current, voltage, frequency, nozzle-work distance, length of arc, angle of electrode, manipulation of the electrode, speed of travel, correct rod or filler selection, and the like.

It is within provision of the invention that the controller be adaptive, for example with feedback based on the user's success during the current or past welds.

It is within provision of the invention to use auto-correction of weld location; for example, in one embodiment the controller may read the seam offset, and provide correction or feedback automatically within given limits. Thus the system may physically move the nozzle to change the seam offset, and/or may indicate to the user how to adjust (while the unit corrects automatically for instance by use of servo motors or other means), and/or may indicate to the user only that a given adjustment is necessary.

In the same way the unit may provide automatic correction and/or feedback concerning weld speed, angle, weaving pattern, current, filler type, the relative tool-seam position, and the like.

It is further within provision of the invention to use a library (in the form of a database, for instance) of weld parameters for use and/or display to the user, for example including speed, distance, weaving parameters, filler type and the like for various situations and desired outcomes. As mentioned above the various situations include different seam types, metal types, work positions and the like. The desired outcomes may include such factors as degree of slag inclusion, depth of weld penetration, heat profile (the temperature of the weld as a function of time and position), weld shape, material profile, weld strength, material usage, and the like.

In certain embodiments of the present invention the tip may be controlled by means of a tip movement unit that provides (for instance) motion perpendicular to the seam direction. This movement unit may have a total travel from 5 to 20 mm, and in some embodiments allows for control over the travel, weave pattern, speed, and the like. Optionally a specific unit may be used with fixed travel motion limits and frequency. The moving tip unit may include provision for control over lateral motion and/or forward/backward motion.

In some embodiments of the present invention, the tip unit is based on servo drives. The design of the moving tip unit may include an eccentric axis mechanism (for example) to provide left-right motion (perpendicular to the seam direction), a settable or programmable amplitude mechanism for changing the degree or amplitude of this motion, and actuating means such as miniature servo motors, ultrasonic motors, piezoelectric motors, solenoids, dc motors, pneumatic actuators, linear motors, and the like.

In some embodiments of the present invention, the welding system includes an optical or vision system that provides feedback to the user. This vision system may be used for showing an image of the seam with various feedback indications, such as temperature, tool-seam distance, electrode angle, speed, and the like. It is within provision of the invention to use various filters embedded in the vision unit to address different illumination conditions. It is further within provision of the invention to use a fiber optic system for transfer of optical information from place to place. For example, visual information from within the nozzle may be obtained by means of a fiber optic vision system.

In some embodiments of the present invention, the vision system uses one or more IR sensors as a means to monitor the welding process.

It is within provision of the invention that the screen for presenting information to the user be employed. This may include an overlay showing desired tool position and the like. The vision system may include optical, IR, and infrared sensitive elements such as CCDs, and optical presentation elements such as LCD screen, OLED screen, or the like. Optionally this may be a touch screen for setting various parameters such as desired weld outcomes (as described above).

In some embodiments of the present invention, electronic opacity control is used to change the level of illumination reaching the detection elements of the vision system. In some embodiments of the present invention, shielding gas is used to protect the vision optical element(s) from sparks, spatter and the like.

It is within provision of the invention that the welding process begin with use of the vision system of the invention. For example the user may half-press on the welding tool trigger to see an image of the work piece, while a full press on the welding tool trigger hides the vision element and begins the welding process.

In some embodiments of the invention the user is shown a video representation of the welding scene, such that in principle the heavily darkened element of the welding mask may be made less dark. In such cases the welding gun of the invention may have shielding elements preventing line-of-sight between user and work, to prevent radiation and spatter from the work from reaching the user. The user is able to observe the work progress on the video screen of the invention, possibly with various overlays indicating such parameters as deviation from desired position, speed, current, voltage, etc.

The system may be adapted for additional scenarios by use of different accessories and tools, for example data acquisition means, group welding provisions, QA monitoring, a training & qualification module, and an automatic mode.

This mode includes a mechanism and algorithms to determine the location of the tip relative to the seam in realtime. Optionally, the movement tip unit is used to provide the motion correction. Alternatively the correction may be done in the weaving direction (i.e. perpendicular to seam) and/or in the direction of the weld seam and/or in the direction perpendicular to the weld seam.

In some embodiments of the invention the weld assist unit is incorporated into a semi- or fully-automated welding system, such as a robotic welding system.

In some embodiments the system can be used for QA inspection of the weld during or after welding.

In some embodiments of the present invention the weld assist unit is fitted with a pace measurement and/or control device that measures and/or controls the speed of the tip movement. Optionally the pace unit indicates to the user if he is moving too fast or too slow. The indication to the user may be in the form of a scale or graph, display, auditory signal, tactile signal, or the like.

In some embodiments of the present invention the pace unit may comprise accelerometers and/or a gyro system. Optionally various other sensors may be used to calculate the speed and path, including inertial measurement systems, magnetometers, inclinometers, optical sensors, and the like. For example the system may be based on RF triangulation, sound wave triangulation, dead reckoning, or any other inertial measurement unit as will be clear to one skilled in the art.

In some embodiments of the present invention the pace unit may be used to calculate the path, speed, and acceleration during use. This information may be used to guide the user and/or to provide feedback for instance in the form of a weld quality assessment. In such an assessment, a plot of the actual path may be presented, measures of average deviation, and other parameters and statistics associated with the weld. Optionally the plot may be overlaid upon a solid model and/or picture of the work piece. Optionally, known geometry of the part being welded may be used in combination with the pace unit to provide accurate data on the welding gun or hand location and desired seam/bead location.

As an example of a measure of deviation, the weld path may be described by a number of points Pᵢ. These may in principle be points including time, such as triples Pᵢ=(Xᵢ,Yᵢ,tᵢ) or quadruples Pᵢ=(Xᵢ,Yᵢ,Zᵢ,tᵢ). The actual path may be similarly described by points Aᵢ. The deviation may then be calculated by means such as the deviation:

$$d = \frac{{\sum }_{i = 1}^{N} \sqrt{{( {P}_{i} - {A}_{i} )}^{2}}}{N - 1}$$

Alternatively the deviation may be calculated without reference to time and only taking into account the difference between desired and actual paths in space.

In some embodiments of the present invention the pace unit is a standalone unit that can be attached as a retrofit to an existing device such as a standard weld torch, to provide pace guidance and/or a QA report.

In some embodiments of the present invention the pace unit can be used as a tool to learn the path of an expert welder, for further reference and/or guidance. In some embodiments of the present invention, the unit may calculate deviation from the desired weld curve (which may take various forms such as that of a straight line, a circle, a pipe intersection geometry, a right angle, or the like.)

In some embodiments of the present invention, the pace unit is used to calculate the weld motion speed, and adjust the wire feed rate in accordance with the weld speed and desired material deposition depth.

In some embodiments of the present invention, a barcode, RFID, QR code, or other reader may be incorporated in the system to provide data on the part. For example the data may include part expected geometry, weld parameters, part material, and desired speed and pace. The tag(s) or other elements being read may be located on the workpiece, at an operator's station, or other location.

In some embodiments of present invention, the part geometry may be used to compare it to the actual path as being currently measured. This knowledge may further optionally be used to provide guidance and/or feedback and/or QA report.

In some embodiments of the present invention the user may indicate to the system the type of weld that is to be performed (for example the curve including straight line, circle, pipe section etc. and/or the type, such as butt weld, lap weld, etc). It is within provision of the invention that the system will calculate actual deviation from the expected geometry during welding execution, for example calculating statistics such as mean squared deviation and the like.

In some embodiments of the present invention the weld assist unit is provided with a sensor giving indication of the torch handle orientation (e.g vertical orientation, horizontal orientation, upside down orientation, or orientation in the form of a set of angles). Based on the unit orientation, a different set of weld parameter may be used to guide the user to perform a better weld.

In some embodiments of the present invention, the weld assist unit provides a ‘quality assurance’ or QA report concerning weld parameters (such as deviation from desired path, heat affected zone and characteristics, weld strength approximation, and the like that can be used to validate the quality of the weld process.

The QA report may be provided in the form of a subsystem, which may be an optional or integral part of the system or the pace unit. Various parameters may be used to provide QA information for example: Weld current, weld voltage, weld frequency, weld speed, weld path, weld deviation from desired path, weld wire feed rate, weld geometry, molten pool characteristics, HAZ characteristics, and the like.

The QA information may be presented to the user or stored in a database. The information may be presented as a graph and/or charts, including presentation of relations between parameters. For example current vs. speed of torch, wire feed vs. speed of torch, deviation from desired path vs. speed of torch, HAZ vs. current, and the like may all be presented to allow the user to assess areas of strength or weakness in welding technique.

A vision and/or optical system may also be used for the QA report. Images and video of the weld or the molten pool can be presented or can be used with additional overlaid info.

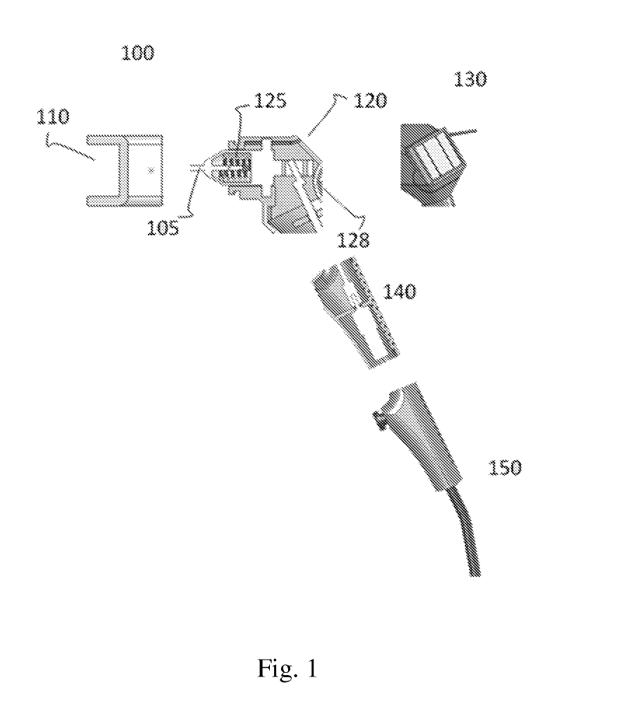

FIG. 1 illustrates an exemplary simplified diagram of the welding system of the invention 100. The system in this example includes a welding tip 105, which provides means to deliver the wire electrode to the weld location. A welding nozzle 110 is attached to the front end of the unit, protecting the shielding gas from the environment, and protecting the user and the rest of the system from the intense light of the welding process. A tip movement unit 120 provides the necessary movement in the lateral direction (perpendicular to the seam). Optionally the tip movement mechanism provides movement along the seam direction.

In some embodiments of the present invention, the tip movement mechanism includes a drive mechanism along the in/out direction of the welding (i.e. into/out of the work piece, changing the work piece—welding tip distance).

In some embodiments of the present invention, sensors are embedded in the movement mechanism and/or the nozzle to provide feedback to the system. In the example a coil 125 is used to measure the current flow thru the tip and thus provide feedback to the system on the welding condition. Optionally a unit such as a current transducer can be used for feedback.

In the example of FIG. 1, an off-center shaft and mechanism 128 is used to provide the lateral ‘weaving’ movement, allowing the operator to use a simpler linear movement. Optionally a display 130 is fitted on the unit to provide feedback to the user. In some embodiments of the present invention a motor 140 is embedded in the unit to provide means to drive the tip movement unit. A handle 150 and an operation button are typically used with the gun. In some embodiments of the present invention, embedded control means such as a microprocessor provides the on line management of the tool, and can optionally be used for additional purposes such as driving the display 130, collecting data, communication with a database, etc. Additional accessories can be used to improve the weld process.

In some embodiments of the present invention an external PC or other computing means is used to provide feedback to the user, including various information that may be found useful and which may be presented automatically and/or by user selection. An external database can be linked to the system to provide optimal parameters and to store various aspects of the process for further use. Optionally the database includes specific information relating to a specific user where the welding parameter and the feedback information to the user and system can be optimal. The database may be network and/or web accessible, allowing for instance multiple users to share data (for instance on what settings are best for what metals, etc). A further database may be supplied for reporting, inspection, and QA purposes.

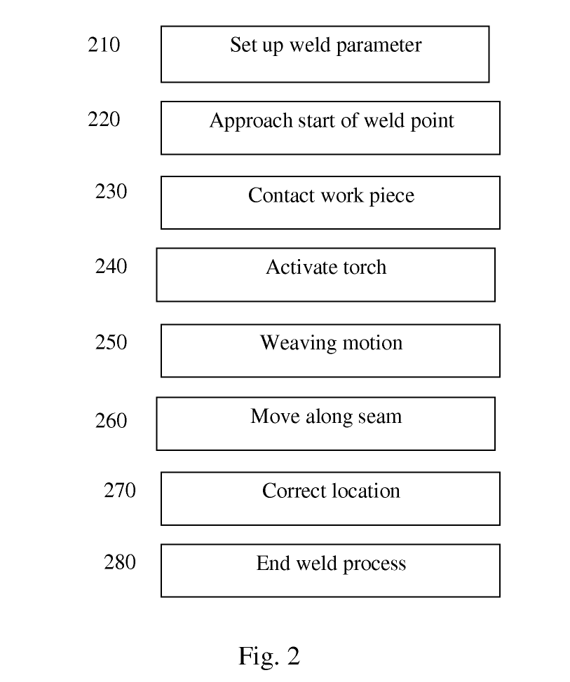

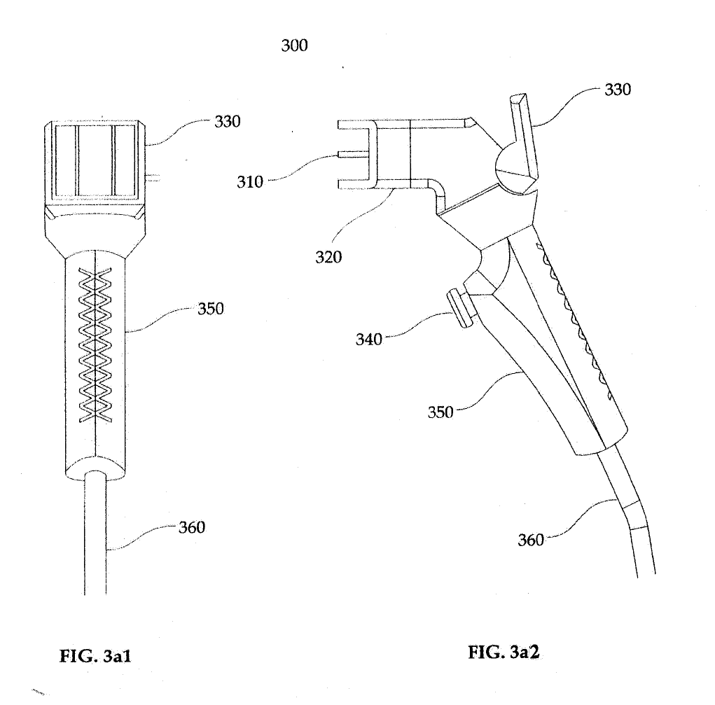

Reference is now made to FIG. 2 showing a system flowchart consistent with some embodiments of the invention. The user first sets welding parameters (210), for example weld speed, feed rate of electrode, and the like. The user then approaches the 1st weld point 220. In some embodiments of the present invention a built-in miniature camera can help the user validate that the tip is pointing to the correct starting position. Upon correct positioning of the tip, electrical contact is obtained 230 and the welding process 240 can begin. In some embodiments of the invention the unit provides the weaving lateral motion 250 while the user moves along the seam 260. In some embodiments of the invention the user corrects the lateral position of the torch; optionally, the unit corrects the lateral position automatically 270, for example within a given range. This process repeats during the welding session unit the user reaches the welding end point 280.

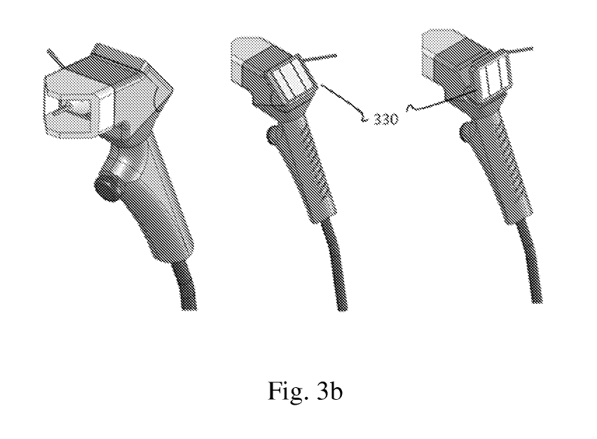

Reference is now made to FIG. 3a,b of another possible embodiment of the invention. An electrode 310 provides the filling material, and nozzle 320 protects the welding area. A display 330 provides feedback to the user. An operation button 340 provides means to activate the system. A handle 350 is used for holding the welding system. A supply cord 360 is used to deliver to the unit various supplies such as the electrode feed, electrical power, shielding gas, control information, and the like.

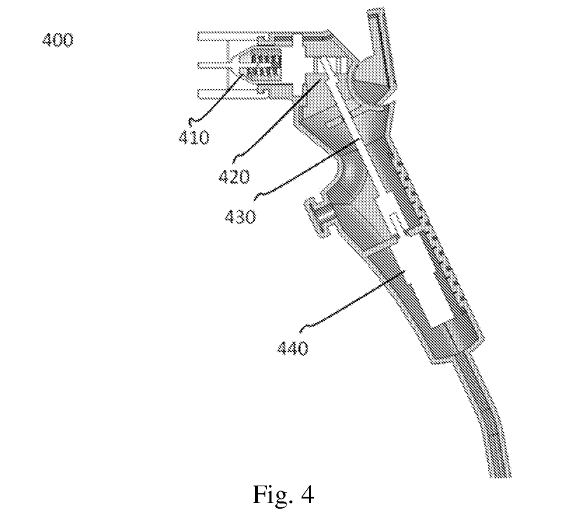

Reference is now made to FIG. 4 showing another possible implementation of the system. A feedback coil (410) is used to measure the electrode current. An off-center (eccentric) mechanism 420 is used to provide the weaving lateral movement. A shaft 430 is used to deliver rotary motion from the motor 440.

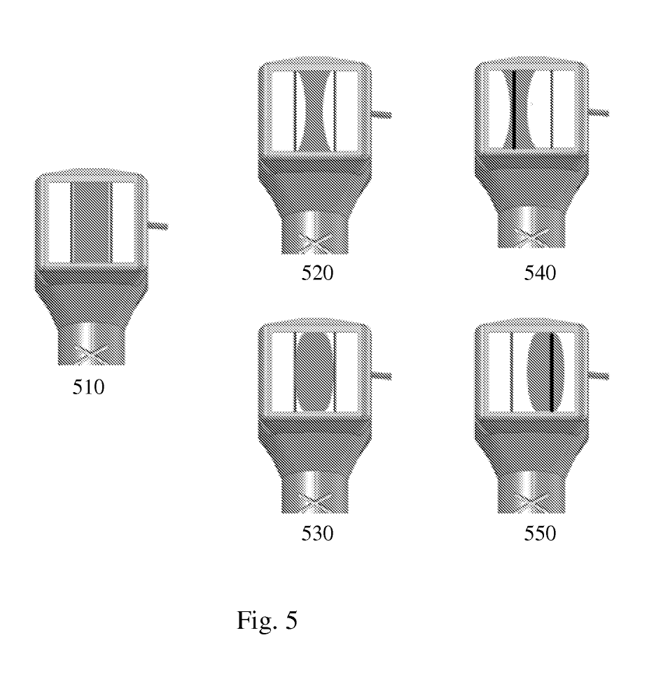

Reference is now made to FIG. 5 where an exemplary display system is shown. The video display (330 of FIG. 3a, b) is shown in various situations. When the user is moving at the right speed and at the center line of the seam an indication is presented to him 510. In case the user moves at inappropriate speed (high 520 or low 530) the display indicates the deviation. Likewise, the system indicates deviation from the desired bead location (540, indicating a fast beat to the left of desired location, and 550, indicating a slow bead to the right of desired location).

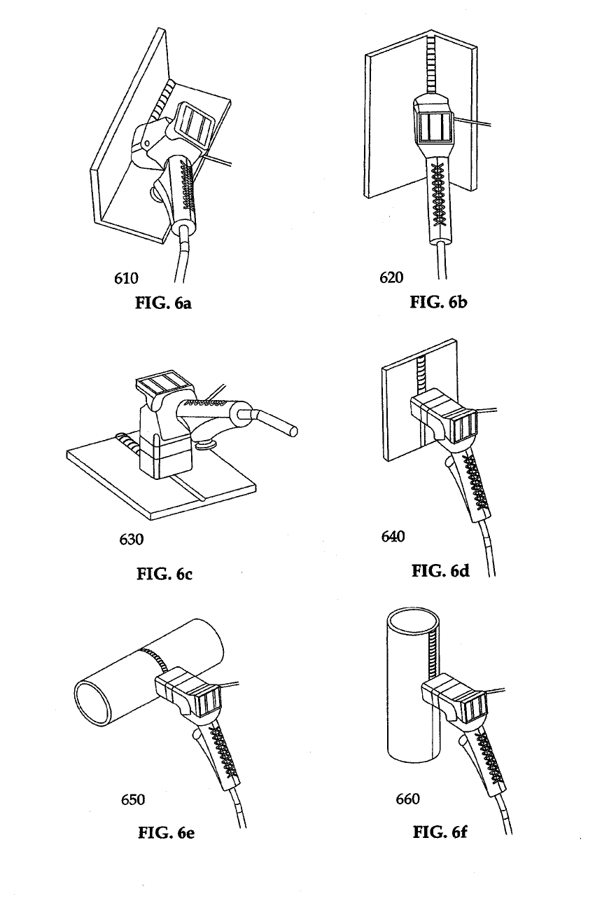

Reference is now made to FIG. 6 where a series of situations using the inventive device are shown. Right angle welding is indicated in 610 and 620 while flat butt welding is shown in 630 and 640. Pipe welding configurations are shown in 650 and 660; a specific nozzle shape may be used for each of these cases. The various nozzles as mentioned may be interchangeable, reusable or disposable.

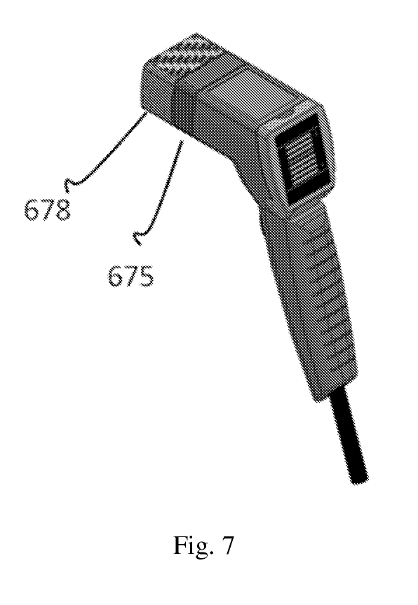

A spacer 675 (FIG. 7) can be used to change the height of the unit relative to the work piece. By resting the nozzle 678 on the work piece an exact distance between seam and nozzle is fixed, allowing in turn an exact arc length to be maintained with no expertise on the part of the operator. Optionally the spacer may be adjusted manually or automatically to a specific height, for example by means of a screw adjustment. The nozzle 678 may be made of brush-like material.

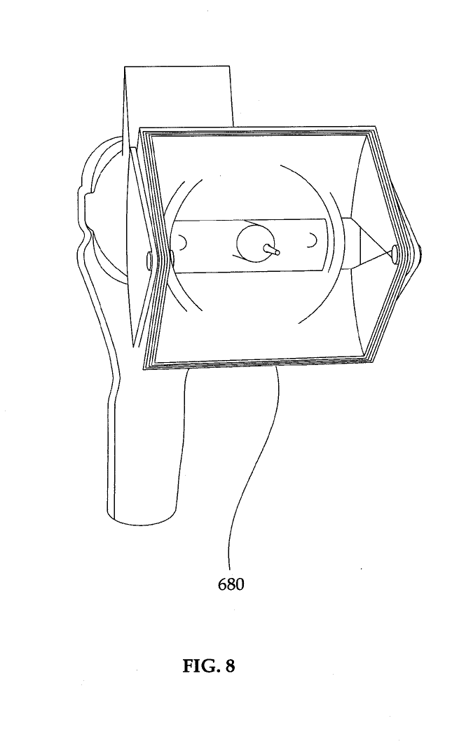

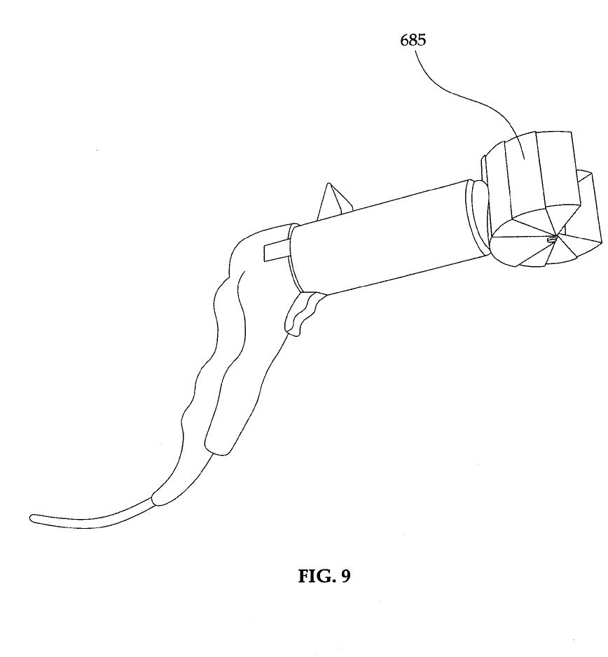

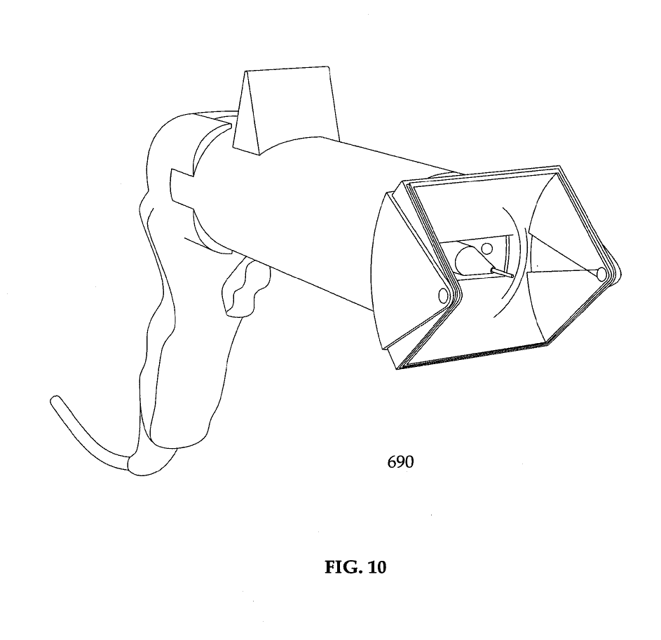

An adjustable angle nozzle (FIG. 8 elements 680, FIG. 9 element 685) may be fitted to the torch to allow for welding different geometries.

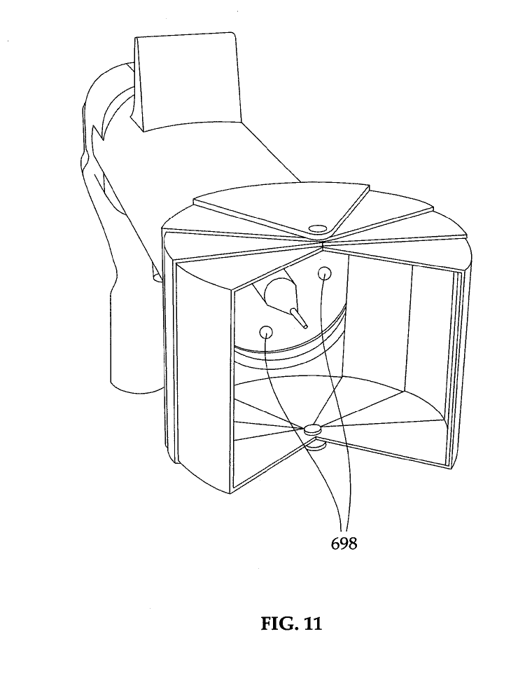

As seen in FIG. 11, in some embodiments of the present invention, the nozzle is fitted with a fiber optic 698 (or multiple fibers) to allow the vision system viewing access to the seam weld.

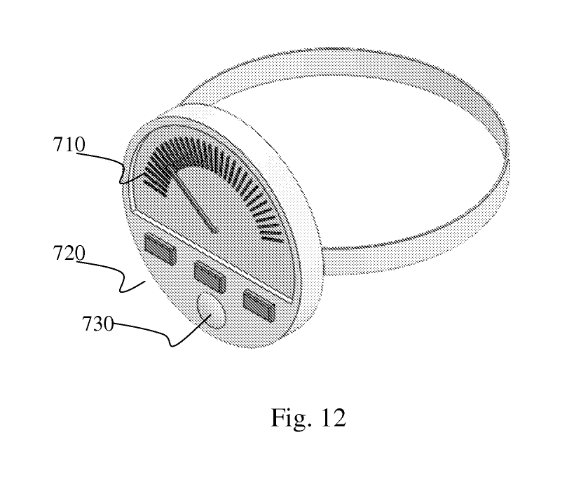

Reference is now made to FIG. 12 where an exemplary pace unit is shown. The unit may have a graphic indicator 710 that provides visual feedback to the user, for example showing the current welding rate relative to the desired one. Optionally a speaker 730 may used to provide audio feedback to the user. Set up button 720 are optional and may be used to record data, to change display and to set parameters. The pace unit may be a stand alone unit, for example wearable on a wrist (700). Optionally the pace unit may be incorporated to the welding unit as indicated in 750.

Optionally the pace unit may be fitted to existing equipment, for example a commercial welding head, a paint spray gun, or the like. As suggested here, the pace unit is useful for any process requiring a tool to move at a given speed and/or on a certain trajectory, such as welding, painting, heat treatment, plasma spraying, drying, wetting, and any number of other industrial processes that may require manual dexterity or for whatever reason are not carried out on a speed-controlled conveyor belt or the like.

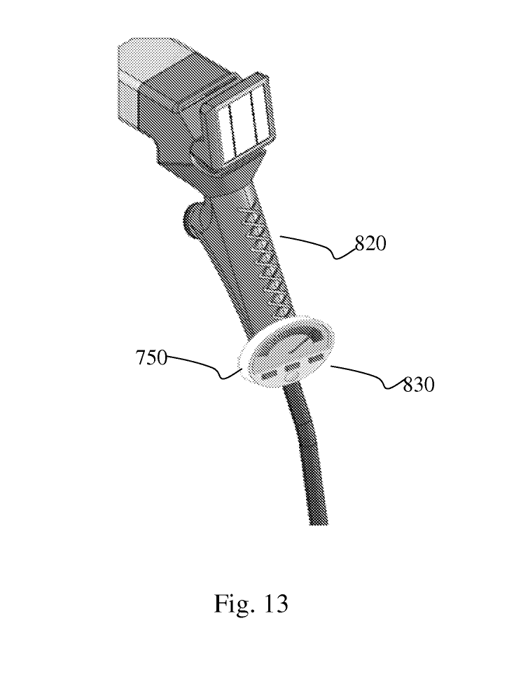

In FIG. 13 an embodiment of a pace system is shown. The pace system may include a welding tool 820 that the pace system is attached or embedded in. An indicator 830 is used to show the actual and/or desired rate of travel, and/or other parameters.

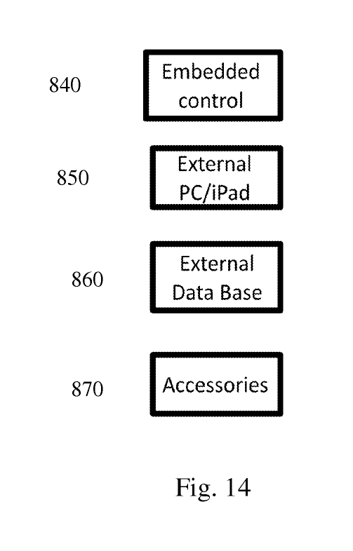

FIG. 14 is a block diagram of certain implementations of the invention. Embedded control 840 such as a CPU, MCU or the like provides real time calculation, as well as a link to external devices such as a personal computer, a cellular phone or a tablet 850. An external data base 860 may also be linked to the system to retrieve and store data. Additional accessories 870 may also be provided with the system.

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

1. An arc-welding assisting device comprising:
at least one sensor adapted to sense parameters of a welding bead;
indicating means adapted to indicate to the user the measurements of said sensors;
whereby realtime feedback is provided to a welder concerning parameters of said welding bead and wherein said at least one sensor comprise at least one position sensor adapted to sense the welding bead position relative to a predetermined desired welding bead position, said at least one position sensor adapted to sense parameters selected from the group consisting of: distance from desired welding bead in the direction parallel to said welding bead; distance from said desired welding bead in the direction perpendicular to said welding bead; welding gun orientation; welding gun position; time derivatives of said welding gun orientation; time derivatives of said welding gun position.

2. (canceled)

3. (canceled)

4. The welding device of claim 1 wherein said sensors comprise speed sensors adapted to measure the speed of production of said welding bead.

5. The welding device of claim 1 wherein said sensors comprise spool speed sensors adapted to measure the rate of spool consumption.

6. (canceled)

7. The welding device of claim 1 further comprising a welding gun and electrode positioning means adapted to move the electrode of said welding gun in a reciprocating movement perpendicular to the direction of said welding bead.

8. The welding device of claim 1 wherein said gun comprises active cooling means.

9. (canceled)

10. (canceled)

11. The welding device of claim 1 wherein said measurements comprise measures of the deviation of said welding bead position from a desired welding bead position.

12. (canceled)

13. (canceled)

14. (canceled)

15. The welding device of claim 1 further comprising means to calculate and plot the path of said bead using said indicating means.

16. (canceled)

17. (canceled)

18. The welding device of claim 1 wherein said indicating means are adapted to show a desired tool path.

19. (canceled)

20. The welding device of claim 1 wherein said indicating means are adapted to indicate weld quality, store and analyze said weld quality information by means of a database, and generate a weld quality report.

21. (canceled)

22. (canceled)

23. A method for welding assistance comprising steps of:
providing at least one sensor adapted to sense parameters of a welding bead;
welding a bead;
modifying the process of welding by means of feedback obtained from indicating means adapted to indicate to the user any corrections necessary indicated by the measurements of said sensors,
wherein said at least one sensor comprise position sensor adapted to sense the welding bead position relative to a predetermined desired welding bead position, said at least one position sensor sense parameters selected from the group consisting of: distance from desired welding bead in the direction parallel to said welding bead; distance from said desired welding bead in the direction perpendicular to said welding bead; welding gun orientation; welding gun position; time derivatives of said welding gun orientation; time derivatives of said welding gun position.

24. (canceled)

25. (canceled)

26. The method of claim 23 wherein said sensors comprise speed sensors adapted to measure the speed of production of said welding bead.

27. The method of claim 23 wherein said sensors comprise spool speed sensors adapted to measure the rate of spool consumption.

28. (canceled)

29. The method of claim 23 further providing a welding gun and electrode positioning means adapted to move the electrode of said welding gun in a reciprocating movement perpendicular to the direction of said welding bead.

30. The method of claim 29 further comprising programming means adapted to allow the user to set parameters of said positioning means.

31. (canceled)

32. (canceled)

33. The method of claim 23 wherein said measurements comprise measure of the deviation of said welding bead position from the desired welding bead position.

34. (canceled)

35. The method of claim 23 wherein said indicating means are wearable.

36. The method of claim 23 wherein said sensors comprise inertial measurement means.

37. The method device of claim 23 further comprising means to calculate and plot the path of said bead.

38. (canceled)

39. (canceled)

40. The method of claim 23 wherein said indicating means are adapted to show a desired tool path.

41. (canceled)

42. (canceled)

43. (canceled)

44. (canceled)
